(19) United States
(12) Patent Application Publication
(10) Pub. No.: US 2004/0033326 A1
(43) Pub. Date: Feb. 19, 2004

(54) Send-reply label

(75) Inventors: Anahit Tataryan, Temple City, CA (US); Ronald Ugolick, San Dimas, CA (US); Betty A. Wright, Anaheim Hills, CA (US)

Correspondence Address: OPPENHEIMER WOLFF & DONNELLY LLP, 840 NEWPORT CENTER DRIVE, SUITE 700, NEWPORT BEACH, CA, 92660, US

(73) Assignee: Avery Dennison Corporation

(21) Appl. No.: 10/222,096

(22) Filed: Aug. 16, 2002

(51) Int. Cl. B32B 9/00

(52) U.S. Cl. 428/42.3; 428/40.1; 428/43

(57) ABSTRACT

A return address label having a send address label formed therein are provided in a printable sheet. The printable sheet includes a release liner, pressure-sensitive adhesive layer, and face stock layer. The pressure-sensitive adhesive layer may be applied to the release liner and the face stock layer may be applied to the pressure-sensitive adhesive layer. The adhesive layer and face stock layer have an outer die cut and an inner die cut. The release liner has a release liner die cut located between the inner and outer die cuts. The outer die cut and the release liner die cut form a return address label and the inner die cut forms a send address label. The send address label is within the outer die cut of the return address label and formed by the inner die cut. The release liner die cut and outer die cut enable the return address label to be removed from the printable sheet having a portion of the pressure-sensitive adhesive layer exposed about a perimeter of the send address label such that the return address label may be adhered to a substrate. The inner die cut enables the send address label to be removed from the return address label and exposing an adhesive layer of the send address label. Name and address information may be printed on the send address label and used for the return address label. The send address label is part of the return address label, therefore, the information printed on the send address label and used as the return address and may be reused as a send address. Alternatively, the return address label may be first applied to an envelope or package to be used as a send address and the send address label may be removed from the return address label and used as the return address label. The information printed on the send address label may be printed using a conventional printer.

### FIELD OF THE INVENTION

The invention relates to a label that may be used as both a return address label and a send address label. More particularly, the invention relates to a multi-label construction having an outer return address label that includes a removable inner send address label.

### BACKGROUND OF THE INVENTION

A label construction that yields more than one label is known. Typically, such labels are manufactured using a piggy-back construction. Piggy-back labels typically have a first pressure-sensitive adhesive applied to one side of a release liner. The release liner also has a second pressure-sensitive adhesive applied to a side of the first release liner opposite the first pressure-sensitive adhesive. A second release liner is then applied to the second pressure-sensitive adhesive. When applying the label to a substrate, the second release liner is removed and discarded and the label is adhered to a substrate using the second pressure-sensitive adhesive layer. This, however, results in a significant waste of material that increases the cost of the final product because one liner is discarded when the label is applied to a substrate. Additionally, this type of construction results in a thicker label from the combined use of multiple layers of liners and adhesive. This type of label construction is also difficult to manufacture.

Another type of label construction is known as a tip-on label. A label is adhered to a release liner and is glued onto a front side of a substrate, thereby eliminating the need for a second release liner. Although this construction results in less waste and reduced production costs, printing and handling problems may still result because of a thickness of the label, liner, and adhesive.

### SUMMARY OF THE INVENTION

The invention relates to labels that may be used as both a return address label and a send address label. The labels may be formed by having the send address label included within the return address label. The labels may comprise a face stock layer, pressure-sensitive adhesive layer, and release liner, and optionally other layers. The pressure-sensitive adhesive layer may be located between the face stock layer and release liner. The labels may be formed on a printable sheet that may be printed using a standard InkJet™, Laser-Jet™, or other printer. The labels may be printed with address information that may be used as both a return address and a send address. Address information may be printed on the send address label. However, because the send address label may be formed within the return address label, the send address information may be first used as the return address and then as the send address. Alternatively, the return address label may be placed in a send address portion of an envelope or package and the send address label may be removed and placed in a return address portion of an envelope or package.

According to certain embodiments of the invention, the release liner, pressure-sensitive adhesive layer, and face stock layer may include one or more outer die cuts that form a removable return address label. The face stock layer and adhesive layer may include at least one inner die cut that forms a second removable label that may be used as a send address label. Therefore, the send address label is formed within an outer die cut that forms the return address label.

In use, and according to one embodiment, a printable sheet may include a plurality of return address and send address labels. The return address label may be removed from the printable sheet by peeling the return address label off of the printable sheet along the outer die cut. A portion of the face stock layer, adhesive layer, and release liner are removed from the printable sheet. An area of the release liner, however, is less than an area of the pressure-sensitive adhesive layer removed from the printable sheet. This enables a portion of the pressure-sensitive adhesive layer to be exposed, enabling the return address label to be adhered to a substrate. After adhering the return address label to a substrate, the send address label may be removed from the return address label by peeling off the send address label along the inner die cut. By peeling off the send address label from the return address label, a portion of the face stock layer and adhesive layer are removed from the release liner of the return address label. Therefore, the pressure-sensitive adhesive layer is exposed along the face stock layer of the send address label, thereby enabling the send address label to be adhered to the same or a different substrate.

According to another embodiment of the invention, a multi-removable label construction includes a face stock layer that is backed with adhesive. The face stock layer includes a cut pattern that defines a removable sub-label within the face stock layer. A release liner member backs and extends beyond the removable sub-label. The release liner member backs less than the entire area of the face stock layer.

The face stock layer may include adhesive coated paper, or any face stock material known in the art. The removable sub-label may include information printed thereon, such as mailing information. The removable label may be provided on a sheet of many labels.

According to one method embodiment of the invention, a method for re-using a portion of a label includes several steps. A label according to the invention is provided. A first removable label is attached to a first substrate. At least one second label is removed from the first removable label by removing at least a portion of the face stock layer and the adhesive layer. The second removable label is attached to a second substrate.

According to another embodiment of the invention, a multi-removable label construction includes a face stock layer that is backed with adhesive. The label includes a first cut pattern in the face stock layer to define an outer label. A second cut pattern in the face stock layer defines at least one inner label within the outer label. A release liner member is applied to the adhesive. A third cut pattern is made in the portion of the release liner member that backs and extends beyond the inner label. The release liner member backs less than the entire area of the face stock layer and the adhesive.

According to another embodiment of the invention, a label assembly includes a face stock layer coated with adhesive. The face stock layer is backed with a release liner. A first line of weakness pattern in the face stock layer defines a removable label. A second line of weakness pattern within the first line of weakness pattern defines a second removable label. The first and second line of weakness patterns extends through the face stock to the release liner. A third line of weakness pattern in the release liner is intermediate to the first and second line of weakness patterns. The third line of weakness pattern extends through the release liner. The label assembly may also include a fourth line of weakness pattern within the first line of weakness pattern defining an additional removable label. The label may further include a fold line for folding the label.

In another embodiment, the release liner is a first release liner. The label may further comprise a second release liner, and a layer of adhesive in between the first release liner and the second release liner to form a multi-layer label. The multi-layer label may include additional lines of weakness to define additional removable label portions.

According to another embodiment, a multi-layer label assembly includes a face stock layer coated with adhesive. The face stock layer may be backed with a first release liner layer. A second release liner layer may back the first release liner. A layer of adhesive may extend between the first and second release liner layers. A first line of weakness pattern in the face stock layer may define a first removable label. The first line of weakness may extend through the face stock layer and the first release liner layer to the second release liner layer. A second line of weakness pattern within the first line of weakness pattern defines a second removable label. The second line of weakness extends through the face stock layer to the first release liner layer. A third line of weakness pattern in the second release liner extends through the release liner but not the face stock layer. The third line of weakness pattern is intermediate to the first and second line of weakness patterns, the third line of weakness pattern extending through the release liner to the face stock layer. A fourth line of weakness pattern in the face stock layer extends through the face stock layer. The fourth line of weakness pattern extends within the second line of weakness pattern, through the face stock layer to the first release liner, and defines a third removable label portion. A fifth line of weakness pattern in the first release liner is intermediate to the fourth line of weakness pattern and the second line of weakness pattern.

In certain embodiments, the lines of weakness are all cuts, such as die cuts. However, there are many alternative embodiments, including those in which lines of weakness, such as perforations, microperforations, cut-and-tie arrangements, slits and/or other lines of weakness known in the art may be used. Other variations and modifications will be apparent from the Detailed Description, the drawings and the claims, and are included within the scope of the invention.

### BRIEF DESCRIPTION OF THE DRAWINGS

FIG. 1A is a top view of a printable sheet that includes a plurality of return address labels and send address labels according to one embodiment of the invention.

FIG. 1B is an exploded cross-sectional view of a printable sheet, return address label, and send address label according to one embodiment of the invention.

FIG. 1C is a top view of a printable sheet that includes a plurality of return address labels having a plurality of inner send address labels according to one embodiment of the invention.

FIG. 2 is a top view of a printable sheet having a plurality of return address labels and send address labels wherein one of the return address labels is partially removed from the printable sheet according to one embodiment of the invention.

FIG. 3 is a top view of a return address label and send address label adhered to an envelope according to one embodiment of the invention.

FIG. 4A is a top view of an envelope having a return address label and a send address label with the send address label partially removed from the return address label according to one embodiment of the invention.

FIG. 4B is a top view of an envelope showing a return address label and a send address label adhered to an envelope according to one embodiment of the invention.

FIG. 5 is a top view of a printable sheet that includes a plurality of outer labels wherein the outer labels include a plurality of inner labels according to one embodiment of the invention.

FIG. 6 is a cross-sectional view of a printable sheet having a plurality of return address labels and/or send address labels according to one embodiment of the invention.

FIG. 7 is a top view of an address seal according to one embodiment of the invention.

FIG. 8 is a top view of an address seal partially adhered to a magazine according to one embodiment of the invention.

### DETAILED DESCRIPTION OF THE PREFERRED EMBODIMENTS

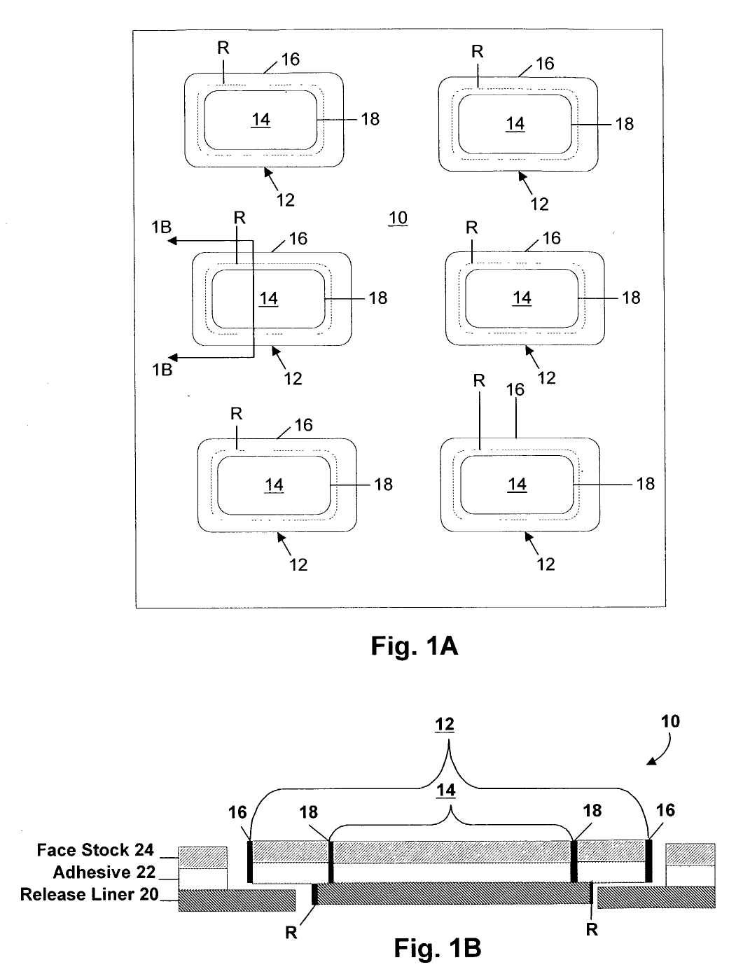

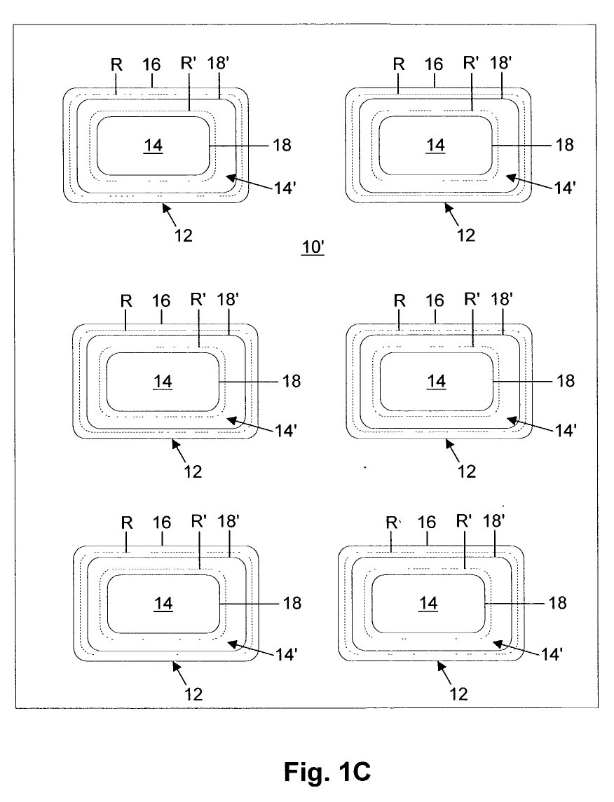

FIG. 1A illustrates a printable sheet 10 having a plurality of return address labels 12 and send address labels 14. The printable sheet 10 preferably includes a face stock layer, pressure-sensitive adhesive layer, and release liner as shown in FIG. 1B. The return address labels 12 may be formed in the printable sheet 10 by forming an outer die cut 16 in the face stock layer and pressure-sensitive adhesive layer and a die cut R in the release liner of the printable sheet 10. The printable sheet 10 may also include at least one inner die cut 18 in the face stock layer and pressure-sensitive adhesive layer that forms the send address labels 14. Various cutting methods known in the art other than die cutting may be used. It should be noted that the send address labels 14 may also be used as return address labels by simply placing the send address labels 14 in a return address portion of an item to be mailed.

The printable sheet 10 preferably has a substantially uniform thickness such that the printable sheet 10 may be inserted into a standard Laser-Jet™, Ink-Jet™, or other conventional printer. The printable sheet 10 may be inserted into a standard printer for printing, for example, names and addresses onto the return address label 12 and send address label 14. The printed names and addresses or other information may be printed within the inner die cut 18. This results in the information being printed on the send address label 14. Although the information may be printed on the send address label 14, because the send address label 14 is part of the return address label 12, the information may be also used for the return address label 12.

FIG. 1B is an exploded cross-sectional view of the printable sheet 10, return address label 12, and send address label 14 shown in FIG. 1A. The return address label 12 and the send address label 14 preferably include a release liner 20. The release liner 20 may include, for example, silicone. A pressure-sensitive adhesive layer 22 may be applied to the release liner 20. A face stock layer 24 may then be applied to the pressure-sensitive adhesive layer 22. The face stock layer 24 may be, for example, an adhesive coated paper or adhesive coated polyester. The pressure-sensitive adhesive layer 22 and face stock layer 24 are preferably provided with an outer die cut 16 that, in combination with die cut R formed in the release liner 20, form the return address label 12.

FIG. 1B also illustrates, as an exploded view, the portions of the release liner 20, adhesive layer 22, and the face stock layer 24 that form the return address label 12 when removed from the printable sheet 10. The return address label 12 includes the portions of the release liner 20 between the die-cut R and the portions of the adhesive layer 22 and the face stock layer 24 between outer die-cut 16.

The inner die cut 18 may be formed in the pressure-sensitive adhesive layer 22 and face stock layer 24. The inner die cut 18 may be used to form the send address label 14. Therefore, the send address label 14 may be removed from the printable sheet 10 with the return address label 12 because the send address label 14 is included in a portion of the adhesive layer 22 and the face stock layer 24 formed by the inner die cut 18 that is removed from the printable sheet 10 when removing the return address label 12.

FIG. 1C illustrates a top view of a printable sheet 10′ according to one embodiment of the invention. The printable sheet 10′ may be formed in a manner as described above with reference to printable sheet 10 shown FIGS. 1A and 1B. Therefore, the printable sheet 10′ may include a return address label 12, send address label 14, outer die cut 16, inner die cut 18, and release liner die cut R. The printable sheet 10′, however, includes an additional inner die cut 18′ and an additional release liner die cut R′. The additional inner die cut 18′ and release liner die cut R′ are preferably formed within the outer die cut 16 and the release liner die cut R. The additional inner die cut 18′ and release liner die cut R′ may be used to form an additional send address label 14′. Therefore, the return address label 16 may include a plurality of inner send address labels 14 and 14′. It should be noted that although the inner send address labels 14, 14′ are termed “send address labels,” they may be used as return address labels simply by placing the send address labels 14, 14′ in a return address portion of an envelope, package or other item being mailed. Although the additional die cuts 18′ and R′ are shown as being within the outer die cut 16 and release liner die cut R, one of ordinary skill in the art is aware that a new outer die cut 16 and release liner die cut R may be formed in an alternating fashion around outer die cut 16 to form a plurality of inner removable send address labels 14, 14′.

It is noted that any number of inner die cuts 18′ and release liner die cuts R may be used to form a plurality of send address labels within the return address labels 12 as shown in FIG. 1C. The outer die cut and the inner die cuts may also be formed such that the return address labels and send address labels are concentric or of varying sizes.

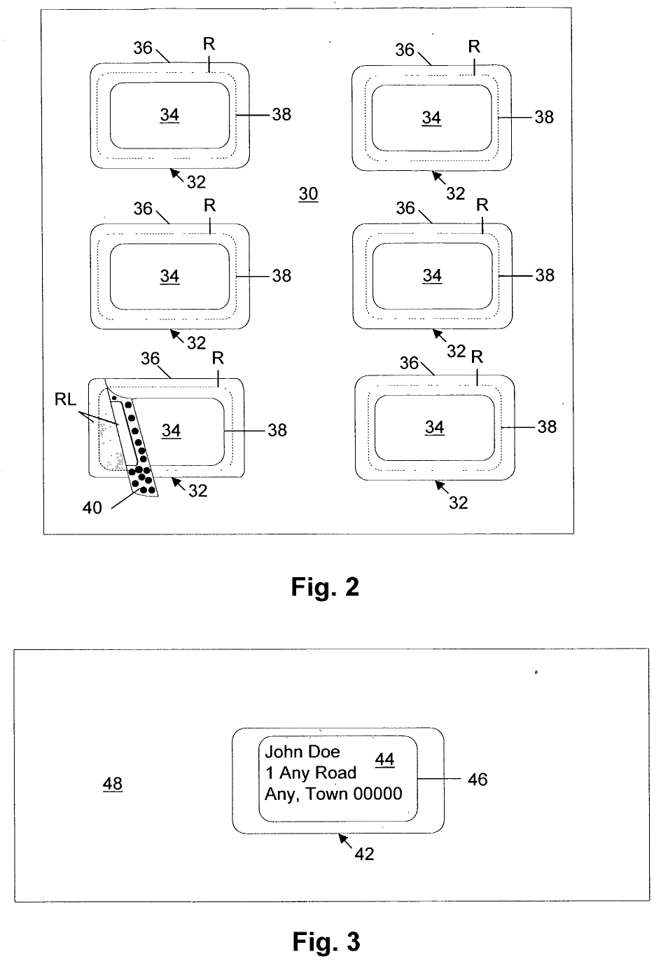

FIG. 2 illustrates a top view of a printable sheet 30 having a plurality of return address labels 32 and send address labels 34. The return address labels 32 may be formed by a die cut R in a release liner RL of the printable sheet 30 and an outer die cut 36 in an adhesive layer and face stock layer of the printable sheet 30. The send address labels 34 may be formed by at least one inner die cut 38 formed in a face stock layer and adhesive layer of the printable sheet 30. FIG. 2 also shows a peeled-back portion of a return address label 32. The peeled-back portion illustrates that the return address label 32 may have an adhesive coating 40 on at least a portion of a back side of the face stock layer of the printable sheet 30. Outer die cut 36 and die cut R enable the return address label 32, which includes the send address label 34, to be removed from the printable sheet 30 and adhered to a substrate. Preferably, the pressure-sensitive adhesive layer of the printable sheet is exposed around a perimeter of the send address label 34 such that the return address label 32 may be adhered to an envelope or other substrate.

FIG. 3 illustrates a send address label 42 having a return address label 44 formed therein by an inner die cut 46 adhered to a send address area of an envelope 48. The send address label 42 having the return address label 44 may be removed from a printable sheet along a die cut in a release liner of a printable sheet and an outer die cut in an adhesive layer and face stock layer of a printable sheet as illustrated in FIG. 2. The die cut in the release liner and outer die cut in the adhesive layer and face stock layer formed in the printable sheet enable a portion of the face stock layer, adhesive layer, and release liner to be removed from the printable sheet. Referring back to FIG. 1B, when the return address label 12 is removed from the printable sheet 10, the die cut R and outer die cut 16 enable a portion of the release liner 20, pressure-sensitive adhesive layer 22, and face stock layer 24 to be removed from the printable sheet 10. An area of the release liner 20 is less than an area of the pressure-sensitive adhesive layer 22 and face stock layer 24. Preferably, the pressure-sensitive adhesive layer 22 and face stock layer 24 are exposed about a perimeter of the release liner 20. The send address label 42 may behave in a similar manner.

Therefore, referring to FIG. 3, a portion of the pressure-sensitive adhesive layer to be exposed around the release liner such that the send address label 42 may be adhered to, for example, envelope 48 shown in FIG. 3 or other substrate. A name and address or other information may be provided on the send address label 42 of the return address label 44. Although provided on the send address label 42, the name and address or other information may also be used for the return address label 44 and vice-versa.

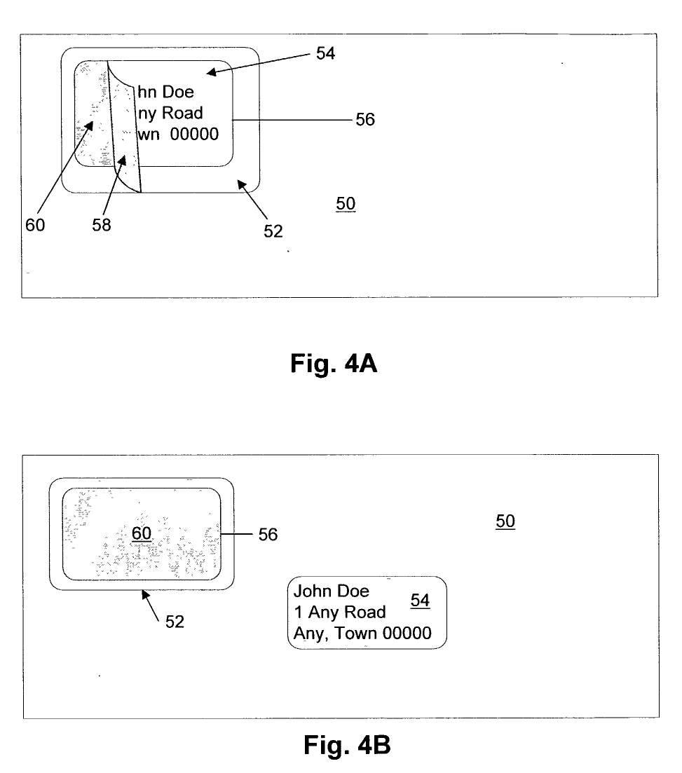

FIG. 4A illustrates an envelope 50 having a return address label 52 adhered thereto. The return address label 52 has a send address label 54 formed therein by an inner die cut 56. FIG. 4A also shows a peeled-back portion of the send address label 54 illustrating that an adhesive 58 may be provided on at least a portion of a back side of the send address label 54.

Inner die cut 56 may be used to remove the send address label 54 from the return address label 52. The send address label 54 may be, for example, peeled from the return address label 52 along die cut 56. The send address label 54 may then be adhered to the envelope 50 as shown in FIG. 4B or another substrate. When removing the send address label 54 from the return address label 52, a release liner 60 may be exposed within inner die cut 56. The release liner 60 enables the send address label 54 to be removed from the return address label 52. The release liner 60 may remain on the envelope 50 as a portion of the return address label 52.

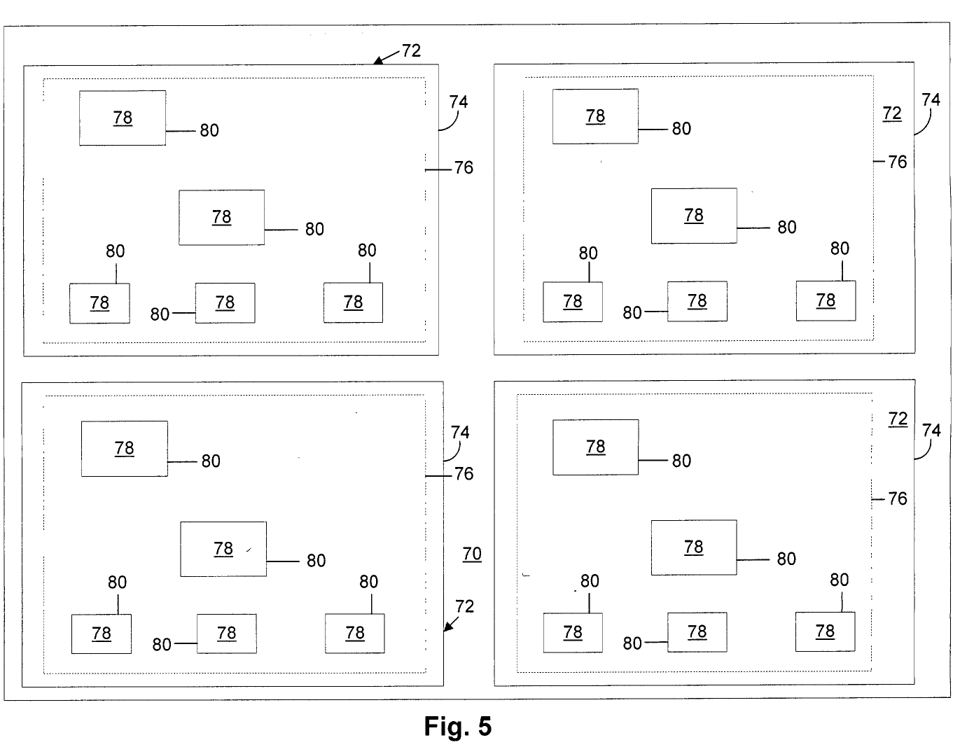

FIG. 5 illustrates a printable sheet 70 that includes a plurality of removable outer labels 72. The outer labels 72 may be formed by an outer die cut 74 formed in a face stock layer and adhesive layer of the printable sheet 70 and an inner die cut 76. The outer labels 72 may be removed from the printable sheet 70 by peeling the outer labels 72 along the outer die cut 74 such that a portion of the face stock layer, adhesive layer, and release liner of the printable sheet 70 are also removed. An area of the release liner removed, however, is less than an area of the face stock layer and adhesive layer because the die cut 76 is formed within the outer die cut 74. Therefore, the portions of the face stock layer and adhesive layer removed extend beyond the portion of the release liner removed. This enables the outer labels 72 to be adhered to a substrate. Preferably, the portion of the face stock layer and adhesive layer extending beyond the release liner is formed around a perimeter of the release liner.

The outer labels 72 may include a plurality of inner labels 78. The inner labels 78 may be formed within the outer labels 72 by forming an inner die cut 80 in the face stock layer and adhesive layer of the printable sheet 70. This enables the inner labels 78 to include an adhesive layer along a back side thereof. The inner labels 78 may then be adhered to the same or a different substrate.

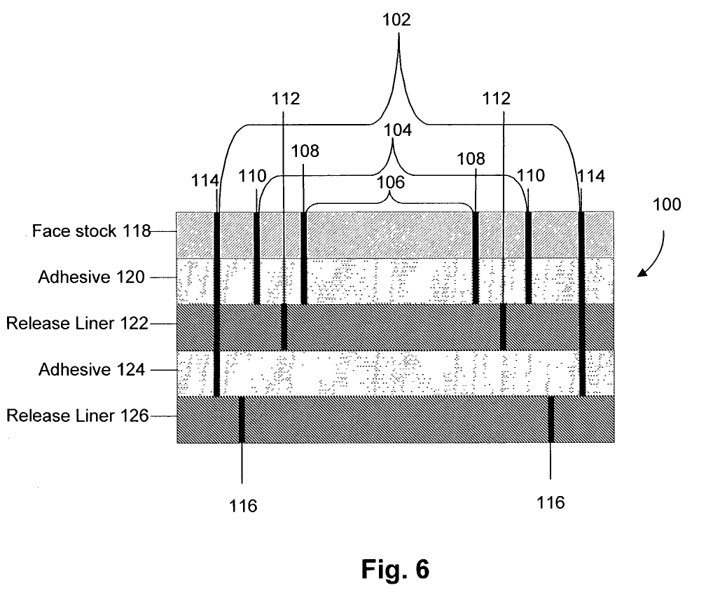

FIG. 6 illustrates a cross-section of a printable sheet 100 that includes a return address label 102 having a plurality of send address labels 104, 106 provided within the return address label 102. The printable sheet 100 includes die cuts 108, 110, and 112. The die cuts 108, 110, and 112 may be formed as shown in FIG. 6. The die cuts 108, 110, and 112 may be used to form the send address labels 104, 106. The die cut 108 may be used to form the send address label 106 and the die cuts 110, 112 may be used to form the send address label 104. Additional die cuts 114, 116 may be used to form the return address label 102. The return address label 102 and the send address labels 104, 106 may be removed in a manner similar to that described in FIG. 1B.

The printable sheet 100 includes a face stock layer 118, adhesive layer 120, and release liner 122 as shown in FIG. 6. The face stock layer 118, adhesive layer 120, release liner 122, and die cuts 108, 110, and 112 may be used in a manner analogous to the printable sheet 10 shown in FIG. 1B. The printable sheet 100, however, includes an additional adhesive layer 124 and an additional release liner 126 not shown in FIG. 1B. These additional layers enable a plurality of send address labels 104, 106 to be included in the return address label 102. Furthermore, the release liner 122 is preferably provided with release coating on both a top side and bottom side thereof. As shown in FIG. 6, the top side and bottom side of the release liner 122 are adhered to the adhesive layer 120 and the additional adhesive layer 124, respectively.

The additional die cut 114 is provided through the face stock layer 118, adhesive layer 120, release liner 122, additional adhesive layer 124, and additional release liner 126. The die cut 116 may be back-cut into the release liner 126. The die cuts 114, 116 may be used to designate the portions of the face stock layer 118, adhesive layer 120, release liner 122, adhesive layer 124, and release liner 126 that are removable from the printable sheet 100. As described above, the portion of the release liner 126 removed from the printable sheet 100 preferably is surrounded by a portion of the adhesive layer 124. This enables the return address label 102 to be adhered to a substrate. Accordingly, each time a send address label 104, 106 is removed from the return address label 102, the portion of the release liner 122 that is removed from the return address label is surrounded by a portion of the adhesive layer 120 such that the send address labels 104, 106 may be adhered to the same or a different substrate as return address label 102.

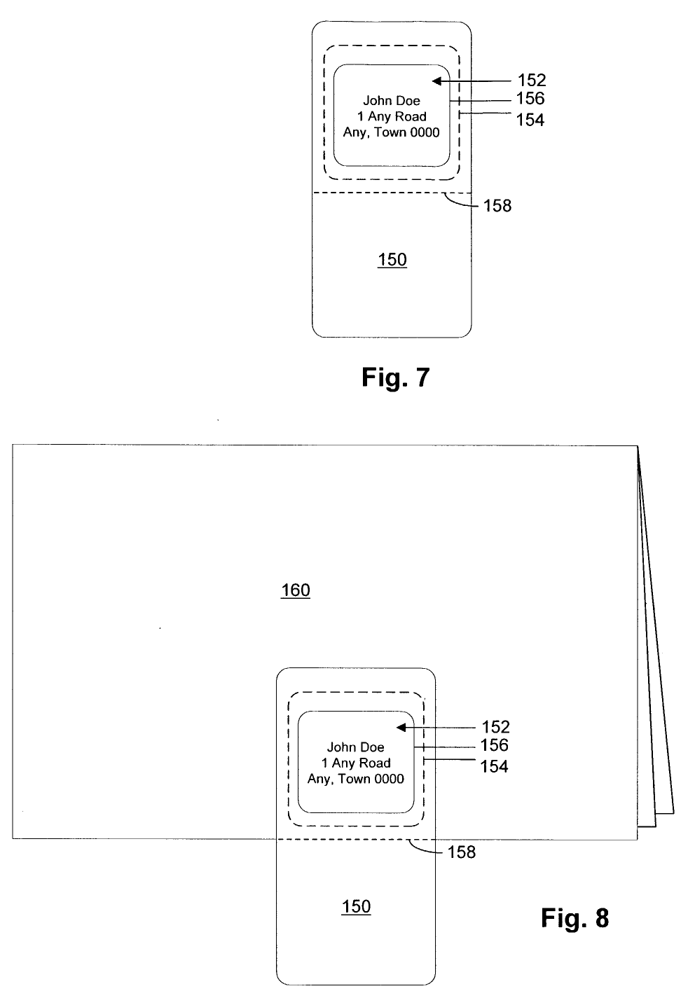

FIG. 7 illustrates an address seal 150 having a removable inner label 152 according to one embodiment of the invention. The address seal may be formed from a printable sheet of material having a face stock layer, pressure-sensitive adhesive layer, and release liner as described above. When removed from the printable sheet, the address seal 150 may include an outer die cut 154 that was formed in the release liner of the printable sheet and an inner die cut 156 formed in the face stock and adhesive layer of the printable sheet that form the removable inner label 152. The die cut 154 outlines a portion of the release liner that was removed from the printable sheet. The remaining underside portion of the address seal may have an exposed layer of adhesive. This enables the address label 150 to be adhered to a magazine or other substrate. Preferably, the address seal 150 may be used to maintain pages of, for example, a magazine, booklet or pamphlet to remain closed while en route to a reader. The address seal 150 may also have a plurality of removable inner labels 152. The plurality of removable inner labels 152 may be provided in a manner as discussed with reference to FIGS. 1A and 1B.

The removable inner label 152 may have mailing or other information printed thereon. The address seal 150 may also have a perforation 158 along a width of the address seal. The perforation 158 enables the address seal to be folded along an edge of the magazine or other material.

FIG. 8 illustrates the address seal 150 adhered to an open side of a magazine 160. The address seal 150 may be adhered to the magazine because, as described above, when the address seal is removed from the printable sheet, a back side of the address seal 150 includes an adhesive layer with only a portion of the adhesive layer having a release liner adhered thereto. The release liner preferably is located behind the removable inner label 152 thus enabling the removable inner label to be removed from the address seal 150 and placed on, for example, a return postcard located within the magazine.

The address seal 150 may be folded along the perforation 158 and adhered to a back cover of the magazine. This enables the address seal 150 to maintain the pages of the magazine in a closed position, yet allow easy opening of the seal

While the specification describes particular embodiments of the present invention, those of ordinary skill can devise variations of the present invention without departing from the inventive concept. The labels may be used as something other than as send address labels, return address labels, and address seals. Information other than names and addresses may be printed on the labels. For example, the labels may be used as tracking labels and “chain of custody” labels. A printable sheet may be inserted into a printer and printed with information to be used for one or more particular types of labels. The inner labels may also be printed with barcode or other tracking information such that the labels may be removed at each location where an envelope or package arrives to indicate that the envelope or package arrived at that location. The inner labels may be provided with medical information, including, for example, a doctor's or other medical personnel's name who is to be responsible for a medical sample. After forwarding the medical sample to other medical personnel, the label for the name of the person forwarding the medical sample may be removed to show a chain of custody.

Perforations, micro-perforations, cut-and-tie arrangements and/or other types of lines of weakness known in the art may be used in lieu of die cuts. Similarly, the cuts may be made with something other than a die cutter, such as a laser cutter or other cutting device known in the art. The labels also need not be in sheet form. The labels, may be, for example, in a roll-form or other form.

It should be noted that the face stock may be any of a wide variety of printable materials, such as paper, cardstock, a polymer film, vinyl, metal foil, or many other materials, which may be coated with a print-receptive coating. Such coatings are known in the art. As a further alternative, the label may be pre-printed, as with a commercial printer, prior to the end-user's receipt of the labels. The labels may also be applied on substrates, such as envelopes, in an assembly-line, mass production fashion. Numerous other variations and modifications may be made within the scope of the invention.

We claim:

1. A multi-removable label construction comprising:
a face stock layer that is backed with adhesive;
a cut pattern in the face stock layer that defines a removable sub-label within said face stock layer;
a release liner member that backs and extends beyond said removable sub-label, and that backs less than the entire area of the face stock layer.

2. The label of claim 1, wherein the face stock layer comprises adhesive coated paper.

3. The label of claim 1, wherein the removable sub-label comprises information printed thereon.

4. The label of claim 3, wherein the information is mailing information.

5. The label of claim 4, wherein said face stock layer comprises an inkjet ink-receptive coating.

6. The label of claim 1, wherein the adhesive layer comprises a pressure-sensitive adhesive.

7. The label of claim 1, wherein said multi-removable label is provided on a sheet comprising a plurality of labels as defined in claim 1.

8. A multi-label sheet assembly comprising:
first removable means for providing a first removable label; and
second removable means for providing at least one second removable label, wherein the at least one second removable label is formed by and within the first removable label.

9. The label of claim 8, wherein the first removable label means comprises adhesive coated paper.

10. The label of claim 9, wherein the second removable label means comprises information printed thereon.

11. The label of claim 9, wherein the first removable label comprises a return address removable label and the at least one second removable label comprises a send address removable label.

12. A method for re-using a portion of a label comprising the steps of:
providing a label as defined in claim 1;
attaching the first removable label to a first substrate;
removing the at least one second removable label from the first removable label by removing at least a portion of the face stock layer and the adhesive layer; and
attaching the at least one second removable label to a second substrate.

13. A multi-removable label construction comprising:
a face stock layer that is backed with adhesive;
a first cut pattern in the face stock layer and the adhesive that defines an outer label;
a second cut pattern in the face stock layer and the adhesive that defines at least one inner label within said outer label;
a release liner member applied to the adhesive; and
a third cut pattern in the release liner member that backs and extends beyond said inner label, and that backs less than an entire area of the face stock layer and the adhesive.

14. The label of claim 13, wherein the face stock layer comprises adhesive coated paper.

15. The label of claim 13, wherein the at least one inner label comprises information printed thereon.

16. The label of claim 15, wherein the information is mailing information.

17. The label of claim 16, wherein said face stock layer comprises an inkjet ink-receptive coating.

18. The label of claim 13, wherein the adhesive layer comprises a pressure-sensitive adhesive.

19. The label of claim 13, wherein said multi-removable label is provided on a sheet comprising a plurality of multi-removable labels.

20. A label assembly comprising:
a face stock layer coated with adhesive;
said face stock layer being backed with a release liner;
a first line of weakness pattern in said face stock layer defining a removable label;
a second line of weakness pattern within said first line of weakness pattern defining a second removable label;
said first and second line of weakness patterns extending through the face stock but not the release liner;
a third line of weakness pattern in said release liner, said third line of weakness pattern being intermediate to said first and second line of weakness patterns, said third line of weakness pattern extending through the release liner but not the face stock layer.

21. A label assembly as defined in claim 20, further comprising a fourth line of weakness pattern within the first line of weakness pattern defining an additional removable label.

22. A label assembly as defined in claim 20, wherein said lines of weakness are die cuts.

23. A label assembly as defined in claim 21, wherein said lines of weakness are die cuts.

24. A label assembly as defined in claim 20, wherein said label further comprises a fold line for folding the label.

25. A label assembly as defined in claim 24, wherein said fold line defines a label section, said second line of weakness pattern being within said label section.

26. A label assembly as defined in claim 20, wherein said release liner is a first release liner, said label further comprising a second release liner and a layer of adhesive in between said first release liner and said second release liner to form a piggy-back label.

27. A label assembly as defined in claim 26, wherein said piggy-back label comprises additional lines of weakness to define additional removable label portions.

28. A multi-layer label assembly comprising:
a face stock layer coated with adhesive;
said face stock layer being backed with a first release liner layer;
a second release liner layer backing said first release liner;
a layer of adhesive between said first and second release liner layers;
a first line of weakness pattern in said face stock layer defining a first removable label, said first line of weakness extending through the face stock layer and the first release liner layer to the second release liner layer;
a second line of weakness pattern within said first line of weakness pattern defining a second removable label, said second line of weakness extending through said face stock layer to the first release liner layer;
a third line of weakness pattern in said second release liner, said third line of weakness pattern being intermediate to said first and second line of weakness patterns, said third line of weakness pattern extending through the release liner but not the face stock layer;
a fourth line of weakness pattern in said face stock layer, said fourth line of weakness pattern extending through said face stock layer, said fourth line of weakness pattern defining a third removable label portion, said fourth line of weakness being within said second line of weakness pattern;
a fifth line of weakness pattern in said first release liner, said fifth line of weakness pattern being intermediate to said fourth line of weakness pattern and said second line of weakness pattern.

29. A label as defined in claim 28, wherein said lines of weakness are die cuts.
